(19) United States
(12) Patent Application Publication
(10) Pub. No.: US 2026/0212677 A1
(43) Pub. Date: Jul. 23, 2026

(54) SYSTEM AND METHOD FOR AUTOMATIC VISUAL THERMAL EVENTS IN A MARITIME ENVIRONMENT

(71) Applicant: ShipIn Systems Inc., Newton, MA (US)

(72) Inventors: David J. Michael, Waban, MA (US); Osher Perry, Newton, MA (US)

(21) Appl. No.: 19/399,313

(22) Filed: Nov. 24, 2025

Related U.S. Application Data
(63) Continuation-in-part of application No. 18/791,211, filed on Jul. 31, 2024.

(51) Int. Cl. G06V 20/52; B63B 43/00; B63B 45/04; B63B 45/08; B63B 79/10; G01J 5/00; G01J 5/48; G06V 10/26; G06V 10/774; G06V 20/40

(52) U.S. Cl. CPC G06V 20/52; B63B 43/00; B63B 45/04; B63B 45/08; B63B 79/10; G01J 5/48; G06V 10/26; G06V 20/44; G01J 2005/0077; G06V 10/774

(57) ABSTRACT

This invention provides a system and method to detect a maritime visual thermal event(s) in shipping containers by acquiring images with a thermal camera, and uses a visual fire precursor events (smoke) based on images of a conventional camera and a computer vision algorithm that is executed on a processor. One precursor is a detectable thermal event where the surface temperature of a ship-based vehicle, cargo, engine, or machinery increases in temperature by a few degrees as recorded by a thermal camera. A second alternate precursor is the appearance of visible compact dense smoke that can be imaged by a conventional visible light camera. The system can be integrated with the existing installed hardware and processes of current systems and methods for maritime event detection with appropriate thermal cameras and data transmission components, at key locations within the ship. Cameras are mounted on the vessel superstructure and/or lashing bridge(s).

### RELATED APPLICATION

This application is a continuation-in-part of co-pending U.S. patent Ser. No. 18/791,211, entitled SYSTEM AND METHOD FOR AUTOMATIC VISUAL THERMAL EVENTS IN A MARITIME ENVIRONMENT, filed Jul. 31, 2024, the teachings of which are expressly incorporated herein by reference.

### FIELD OF THE INVENTION

This invention relates to systems and methods for detecting and communicating information related to maritime events, and more particularly to detection of events related to conditions that may lead to overheating and or fire onboard a commercial vessel transporting deck-stacked containerized cargo.

### BACKGROUND OF THE INVENTION

International shipping is a critical part of the world economy. Ocean-going, merchant freight vessels are employed to carry virtually all goods and materials between ports and nations. The current approach to goods shipments employs intermodal cargo containers, which are loaded and unloaded from the deck of ships, and are carried in a stacked configuration. Freight is also shipped in bulk carriers (e.g. grain) or liquid tankers (e.g. oil). The operation of merchant vessels can be hazardous and safety concerns are always present. Likewise, passenger vessels, with the precious human cargo are equally, if not more, concerned with safety of operations and adherences to rules and regulations by crew and passengers. Knowledge of the current status of the vessel, crew and cargo can be highly useful in ensuring safe and efficient operation.

Commonly assigned U.S. Pat. No. 11,132,552, entitled SYSTEM AND METHOD FOR BANDWIDTH REDUCTION AND COMMUNICATION OF VISUAL EVENTS, issued Sep. 28, 2021, by Ilan Naslavsky, et al. (the teachings of which are incorporated herein by reference) teaches a system and method that addresses problems of bandwidth limitations in certain remote transportation environments, such as ships at sea, and is incorporated herein by reference as useful background information. According to this system and method, while it is desirable in many areas of commercial and/or government activity to enable visual monitoring (manual and automated surveillance), with visual and other status sensors to ensure safe and rule-conforming operation, these approaches entail the generation and transmission of large volumes of data to a local or remote location, where such data is stored and/or analyzed by management personnel. Unlike most land-based (i.e. wired, fiber or high-bandwidth wireless) communication links, it is often much more challenging to transmit useful data (e.g. visual information) from ship-to-shore. The incorporated U.S. application teaches a system and method that enables continuous visibility into the shipboard activities, shipboard behavior, and shipboard status of an at-sea commercial merchant vessel (cargo, fishing, industrial, and passenger). It allows the transmitted visual data and associated status be accessible via an interface that aids users in manipulating, organizing and acting upon such information.

On maritime cargo vessels the risks due to fire are substantial. That is why smoke and fire detection equipment and sensors are required aboard these vessels often along with automatic fire abatement systems. Unfortunately, once a fire is large enough to be detected by the existing smoke and fire detection equipment, even if the fire abatement systems activate, significant damage may have already occurred to the vessel and cargo. In some cases, like active fires of electric vehicles battery systems, abatement of the fires can be difficult or impossible once the fire actively breaks out, and/or the fire cannot be extinguished without burning through an entire vehicle battery system (or in two recent cases, burning through an entire ship) causing significant, or even catastrophic fire damage.

A second example where detecting a fire precursor can prevent a full-blown fire is in the marine engine space. In this case, flammable liquids like oil often are accidentally released in the marine engine space. If an exposed surface is hot, say over the ignition temperature of the flammable liquid a fire contact between the flammable liquid and the hot surface would immediately start a fire. Detecting the hot surface and addressing its root cause would eliminate this cause of fire.

A third example would be to detect when the temperature of a surface is rising, but before it has risen enough to be a precursor to fire. In that case, there would be time for crew to address the temperature increase well before a fire is likely to start.

Given early detection, in the case of an electric vehicle battery pack, the entire car can be enclosed in a fire blanket. Likewise, in the case of a marine engine unit, that unit could be shut down for maintenance before a fire breaks out.

A particular concern in container ships, which carry stacked intermodal containers on their deck, is that contents of one or more of those containers—for example those housing potentially flammable objects or materials (e.g. electric vehicles (EVs) and/or other battery-powered devices)—can catch fire, which is discovered only after the fire has become critical, with smoke and flames spreading to other containers on the deck. Typical at-risk cargo is lithium batteries which can overheat, short-circuit or enter thermal runaway. These batteries can be in isolation, or more-likely already integrated with electronics, toys, bikes, EVs, power banks, etc. Other at-risk cargo are chemicals and oxidizing substances. Additionally, charcoal, coconut shell products, wood pellets, fishmeal can self-heat due to oxidation of a large concentration/mass of these materials. Metal powders are also high reactive especially with moisture and can spontaneously ignite. Recyclables sometimes contains batteries, aerosols or chemicals which shouldn't be packed together. Many of these items can be inadvertently or deliberately mis-declared to shipping administrators. If items are not mis-declared, then at-risk containers are typically spread out and separated by large buffers of neutral items and stored in known locations. However, absent careful arrangement of containers on a vessel, these at-risk containers can ignite and spread to other flammable containers.

It is thus, desirable to provide a system for economically and reliably detecting heat and fire conditions on a maritime vessel, and particularly with respect to at-risk container contents, before these conditions become a major emergency. This system should also allow for logging of events to assist in determining potential problems and unsafe conditions on vessels and fleets.

### SUMMARY OF THE INVENTION

This invention overcomes disadvantages of the prior art by providing a system and method to detect a maritime visual thermal event(s) for carried vehicles, cargo, marine engines, and machinery that is based on images taken with a thermal camera (for the detecting the rising temperature precursor) and a second method to detect a maritime visual fire precursor event based on images taken with a conventional camera and a computer vision algorithm that is executed on a processor. If instead of needing to wait for the fire to actively break out, be detected, and abatement activated, the system can effectively detect a precursor to that fire, such as a rising temperature that can lead to fire or some other visible signature that serves as a precursor to fire. Upon early detection, time may exist to prevent a possible fire, and avoid the significant damage. One precursor is a detectable thermal event where the surface temperature of a ship-based vehicle, cargo, engine, or machinery increases in temperature by a few degrees as recorded by a thermal camera. A second alternate precursor is the appearance of visible compact dense smoke that can be imaged by a conventional visible light camera. This novel thermal event detection system can be integrated with the existing installed hardware, operation and processes of current systems and methods for maritime event detection described above with the addition of appropriate thermal cameras and data transmission components, mounted at key locations within the ship's environment.

The above-described system and method can be applied to at-risk containers in a container ship having rows and columns of stacked containers arranged on a deck, and in the hold of the ship. Illustratively, some or all of the thermal imaging cameras employed herein can be used to image known locations for such at-risk containers, or can be used to image at least a portion of substantially all containers carried on the vessel. The thermal and/or conventional camera(s) are installed and fixed on the superstructure and/or lashing bridge(s) of a container ship. The camera acquire an image of at least one face/side of each container of interest and periodically compare the acquired image(s) to reference image(s) of the same container/location. These reference image(s) can be trained from prior images of container(s) in that location and/or from near-real time images acquired after loading of the present group of containers being shipped (and before a fire/smoke event occurs).

In an illustrative embodiment, a system and method for automatically detecting a thermal event in a commercial maritime vessel carrying shipping containers as part of an automated visual event detection system is provided. At least one thermal camera mounted to image at least one side of one of the shipping containers for thermal events. At least one processor resides on the vessel, and is adapted to receive thermal image data over a local network from the at least one thermal camera and generate thermal event information relative to the data. A data store is associated with the processor, and receives thermal image data from the thermal camera of the at least one side. The data store provides live thermal images of the at least one side and storing reference images of the at least one side associated with a plurality of conditions. A thermal event determination process periodically compares one or more reference images of an area containing the at least one of the shipping containers, including the at least one side, to a set of the conditions in one or more acquired current thermal images of the at least one side by the at least one thermal camera. The process determines therefrom whether a thermal event condition is present based upon the acquired current thermal images. Illustratively, a communication link that transmits, based upon predetermined threshold conditions, the thermal event information from the processor to a land-based remote computer system that stores, analyzes and displays the thermal event information. The communication link can define a reduced bandwidth, in which the information is transmitted in an order as part of a hierarchy of event information based upon significance thereof. A storage arrangement can reside on the vessel in association with the processor, which stores the thermal event information, including a time and a duration of the thermal event in a land-based database on shore or in a cloud data storage. The at least one thermal camera can be located on a superstructure or lashing bridge of the vessel. Weatherproof cables can carry power and data to and from the at least one thermal camera, and can be operatively connected with the processor. The at least one thermal camera can image a plurality of sides associated, respectively, with a plurality of adjacent shipping containers. Each thermal image can be divided into temperature measurement zones that are analyzed separately for change in temperature in a plurality of thermal images by the processor. A tracking process can align the temperature measurement zone in a first of the plurality of thermal images to a second thermal images. The tracking process can include an alignment process that chooses from at least one of a plurality of alignment methods. A comparison process can compare the two aligned temperature measurement zones using a minimum criteria for temperature or change in temperature consisting of both a minimum contiguous area and a minimum temperature, or a change in temperature. A determination process can convert a result of the comparison process into a visual alert that is reported to a user. The processor can receive visual event information of compact smoke from images acquired by at least one visual camera of the at least one of the shipping containers, and determines presence of compact smoke based upon predetermined characteristics in one or more of the images. The predetermined characteristics can include a time of the determined presence and a duration of the determined presence of compact smoke in at least two of the images. A communication link can transmit, based upon predetermined conditions, the visual event information of compact smoke from the processor to a land-based remote computer system that stores, analyzes and displays the visual event information of compact smoke. An attention process can define an attention zone in the image to search for the compact smoke. The processor can include at least one of a conventional computer vision process and a deep learning computer vision process that detects the compact smoke in each of the images, and a comparison process that uses results of the at least one of the conventional computer vision process and the deep learning computer vision process computer vision method, in combination with attention process, to validate the detection of the compact smoke. A determination process can use respective detection of the compact smoke from a two or more images to provide a visual alert of the compact smoke to a user. The processor can be operatively connected to instruct a vessel-based alarm system to issue at least one of an audible and visible alert based upon determination of the thermal event condition.

### BRIEF DESCRIPTION OF THE DRAWINGS

The invention description below refers to the accompanying drawings, of which:

FIG. 1 is a diagram showing an overview of a system and associated method for acquiring, transmitting analyzing and reporting visual and other sensor information with respect to a communication link, including processes/ors for automatically diagnosing/detecting thermal events based upon thermal image data acquired by one or more thermal cameras mounted at various locations within the maritime (e.g. cargo) vessel according to an illustrative embodiment;

FIG. 1A is a block diagram showing data and operations employed by the system and method of FIG. 1;

FIG. 1B is a diagram showing acquisition of images and other data for expected event detection according to the system and method of FIG. 1;

FIG. 2 is a flow diagram showing detection and reporting of visual events and associated data by the processors and processes of the system and method of FIG. 1;

FIG. 3 is a flow diagram showing the detection of visual events using processors and processes of the system and method of FIG. 1 in the example of a bridge routine on a sea-going merchant/cargo vessel;

FIG. 4 is a flow diagram showing the detection of visual events using processors and processes of the system and method of FIG. 1 in the example of the performance of safety rounds by personnel (crew) on a sea-going merchant vessel;

FIG. 5 is a flow diagram showing the detection of visual events using processors and processes of the system and method of FIG. 1 in the example of performing activities with respect to cargo handling on a sea-going merchant vessel;

FIG. 6 is a flow diagram showing a generalized procedure for detecting thermal conditions based upon acquired thermal image(s) of an area of the vessel and reference image(s) and/or thresholds of the area acquired at similar times and/or under similar conditions, in association with the arrangement of FIG. 1;

FIG. 7 is a flow diagram showing a training phase procedure for the thermal event detection process of FIG. 6;

FIG. 8 is a flow diagram showing a runtime phase procedure for the thermal event detection process of FIG. 6;

FIG. 9 is a flow diagram showing a training phase procedure for smoke detection using a visual camera in association with the arrangement of FIG. 1;

FIG. 10 is a flow diagram showing a runtime phase procedure for smoke detection using a visual camera in association with the arrangement of FIG. 1;

FIG. 11 is a side view of an exemplary container-carrying cargo vessel (container ship) showing a typical stacked container layout relative to lashing bridges and placement of thermal imaging cameras to capture images of the stacked containers according to an illustrative embodiment;

FIG. 12 is a top view of the container ship with thermal imaging cameras according to FIG. 11;

FIG. 13 is a fragmentary frontal view of a superstructure of a container ship showing exemplary placement locations for thermal imaging cameras to carry out the system and method herein; and

FIG. 14 is a fragmentary side view of a portion of the container ship showing an exemplary deployment of thermal imaging cameras on a lashing bridge so as to image exemplary containers adjacent to a lashing bridge.

### DETAILED DESCRIPTION

### I. System Overview

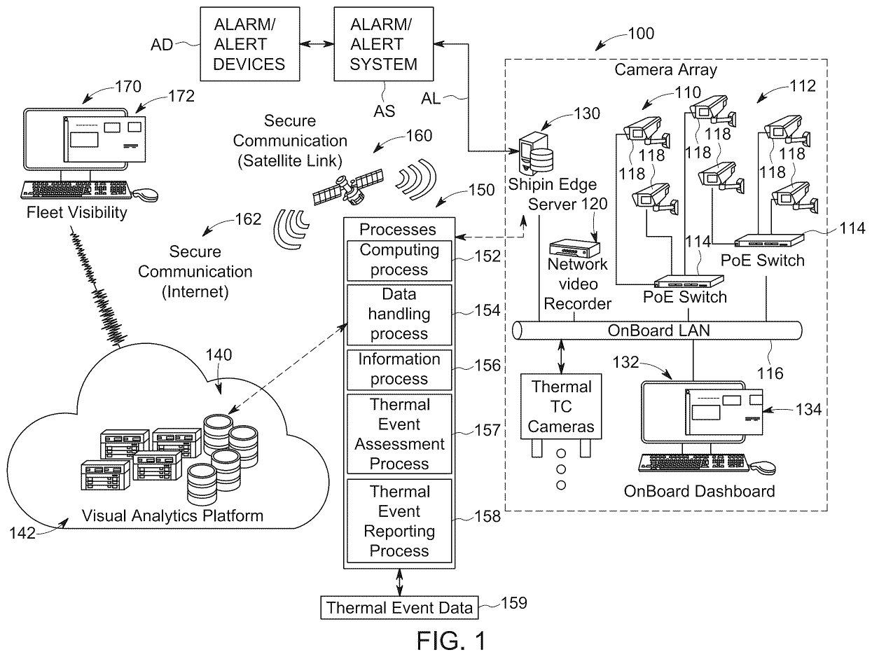

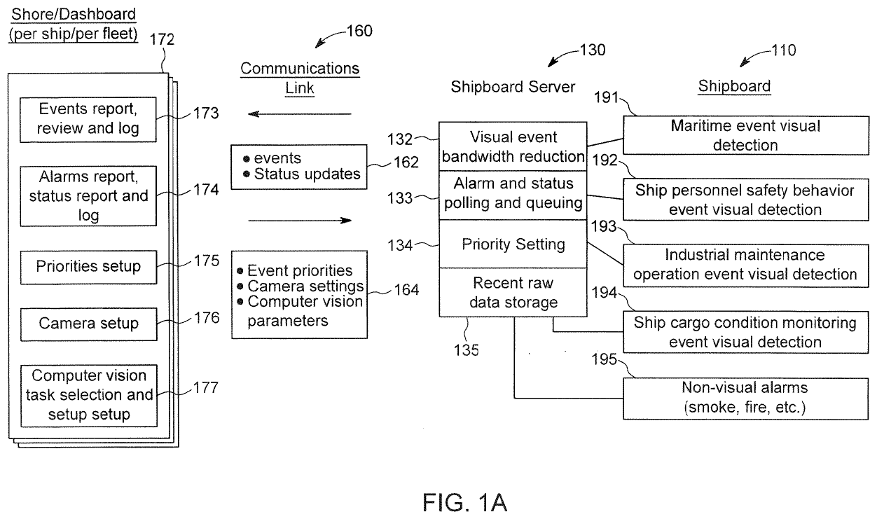

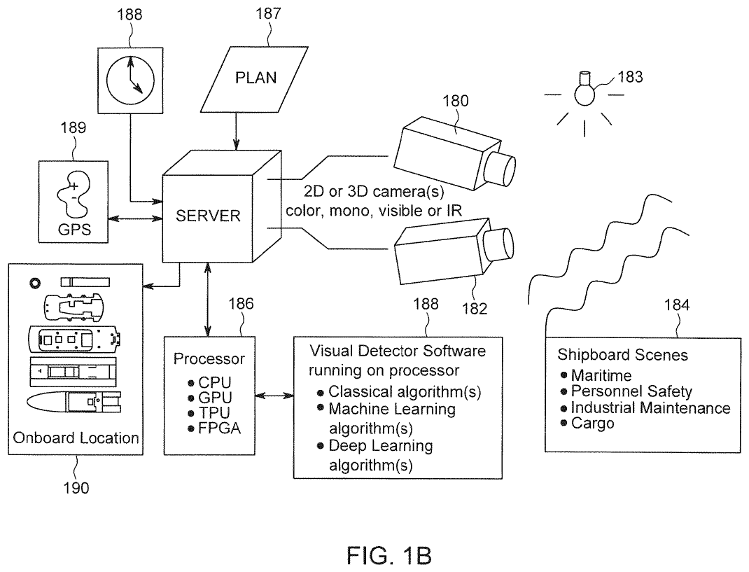

FIGS. 1 and 1A show an arrangement 100 for tracking and reporting upon visual, and other, events generated by visual sensors aboard ship that create video data streams, visual detection of events aboard ship based on those video data streams, aggregation of those visual detections aboard ship, prioritization and queuing of the aggregated detections into events, optional bandwidth reduction of the video data streams in combination with the aggregated events, sending the events over the reduced bandwidth communications channel to shore, reporting the events to a user-interface on shore, and further aggregation of the events from multiple ships and multiple time periods into a fleet-wide aggregation that can present information over time. The system and method herein further provides the ability to configure and setup the system described above to select or not select events for presentation in order to reduce confusion for the person viewing the dashboard as well as to set the priority for communicating particular events or classes of events. Such communication can optionally occur over the reduced bandwidth communications channel so that the most important events are communicated at the expense of less important events.

FIG. 1, the arrangement 100 particularly depicts a shipboard location 110 includes a camera (visual sensor) array 112 comprising a plurality of discrete digital cameras 118 (and/or other appropriate environmental/event-driven sensors) that are connected to wired and/or wireless communication links (e.g. that are part of a TCP/IP LAN or other protocol-driven data transmission network 116) via one or more switches, routers, etc. 114. Image (and other) data from the (camera) sensors 118 is transmitted via the network 116. Note that cameras can provide analog or other format image data to a remote receiver that generates digitized data packets for use of the network 116. The cameras 118 can comprise conventional machine vision cameras or sensors (based upon CMOS, CCD, etc.) operating to collect raw video or digital image data, which can be based upon two-dimensional (2D) and/or three-dimensional (3D) imaging. Furthermore, the image information can be grayscale (monochrome), color, and/or near-visible (e.g. infrared (IR)). Likewise, other forms of event-based cameras can be employed.

Note that data used herein can include both direct feeds from appropriate sensors and also data feeds from other data sources that can aggregate various information, telemetry, etc. For example, location and/or directional information can be obtained from navigation systems (GPS etc.) or other systems (e.g. via APIs) through associated data processing devices (e.g. computers) that are networked with a server 130 for the system. Similarly, crew members can input information via an appropriate user interface. The interface can request specific inputs—for example logging into or out of a shift, providing health information, etc.—or the interface can search for information that is otherwise input by crew during their normal operations—for example, determining when a crew member is entering data in the normal course of shipboard operations to ensure proper procedures are being attended to in a timely manner.

The shipboard location 110 can further include a local image/other data recorder 120. The recorder can be a standalone unit, or part of a broader computer server arrangement 130 with appropriate processor(s), data storage and network interfaces. The server 130 can perform generalized shipboard, or dedicated, to operations of the system and method herein with appropriate software. The server 130 communicates with a work station or other computing device 132 that can include an appropriate display (e.g. a touchscreen) 134 and other components that provide a graphical user interface (GUI). The GUI provides a user on board the vessel with a local dashboard for viewing and controlling manipulation of event data generated by the sensors 118 as described further below. Note that display and manipulation of data can include, but is not limited to enrichment of the displayed data (e.g. images, video, etc.) with labels, comments, flags, highlights, and the like.

As shown in FIG. 1, the ship-based server/computing device 130 can be directly connected (link AL) to an existing or additional ship-based alert or alarm system AS. This connection can be over the ship-based LAN, wireless transceivers (e.g. 802.11(g), etc.), or through a hardware link-like direct relay, serial or ethernet. Protocols for communication with could be direct, CANBus, Modbus, meeting regulatory requirements such as NFPA 72. When an alarm is triggered (e.g. by a thermal event as described herein, the server 130 communicates with the alert/alarm system AS, which then issues alert commands to various alert devices AD via a wired or wireless link. Such alert devices can include, but are not limited to alarms, sirens, bells, horns, lights, and strobes. The alerts can be ship-wide, or localized to a particular area in which the event is detected based upon data provided by the server 130 and the capabilities of the alert system AS to localize alarms. Likewise, a serious event can dictate a ship-wide alert regardless of localization and/or additional alarms can be localized at the event site—e.g. strobes in the container bay in which rising heat is detected.

The information handled and/or displayed by the interface can include a workflow provided between one or more users or vessels. Such a workflow would be a business process where information is transferred from user to user (at shore or at sea interacting with the application over the GUI) for action according to the business procedures/rules/policies. This workflow automation can be implemented in a variety of manners that include a computer and network arrangement, and in an embodiment, can be referred to as “robotic process automation.”

The processes 150 that run the dashboard and other data-handling operations in the system and method can be performed in whole or in part with the on-board server 130, and/or using a remote computing (server) platform 140 that is part of a land-based, or other generally fixed, location with sufficient computing/bandwidth resources (a base location 142). The processes can generally include 150 a computation process 152 that handles sensor data to meaningful events. This can include machine vision algorithms and similar procedures. A data-handling process 154 can be used to derive events and associated status based upon the events—for example movements of the crew and equipment, cargo handling, etc. An information process 156 can be used to drive dashboards for one or more vessels and provide both status and manipulation of data for a user on the ship and at the base location.

Data is communicated between the ship (or other remote location) 110 and the base 142 occurs over one or more wireless channels, which can be facilitated by a satellite uplink/downlink 160, or another transmission modality—for example, long-wavelength, over-air transmission. Moreover, other forms of wireless communication can be employed such as mesh networks and/or underwater communication (for example long-range, sound-based communication and/or VLF). Note that when the ship is located near a land-based high-bandwidth channel or physically connected by-wire while at port, the system and method herein can be adapted to utilize that high-bandwidth channel to send all previously unsent low-priority events, alerts, and/or image-based information.

The (shore) base server environment 140 communicates via an appropriate, secure and/or encrypted link (e.g. a LAN or WAN (Internet)) 162 with a user workstation 170 that can comprise a computing device with an appropriate GUI arrangement, which defines a user dashboard 172 allowing for monitoring and manipulation of one or more vessels in a fleet over which the user is responsible and manages.

Referring further to FIG. 1A, the data handled by the system is shown in further detail. The data acquired aboard the vessel environment 110, and provided to the server 130 can include a plurality of possible, detected visual (and other sensor-based) events. These events can be generated by action of software and/or hardware based detectors that analyze visual images and/or time-sequences of images acquired by the cameras. With further reference to FIG. 1B, visual detection is facilitated by a plurality of 2D and/or 3D camera assemblies depicted as cameras 180 and 182 using ambient or secondary sources of illumination 183 (visible and/or IR). The camera assemblies image scenes 184 located on board (e.g.) a ship. The scenes can relate to, among other subjects, maritime events, hull and machinery, personnel safety and/or cargo, and cameras can be mounted to image a variety of locations on the (e.g.) sea-going cargo vessel, including the bridge, deck, hold(s), engine room(s), machinery room(s), steering gear room, crew quarters, hallways, etc. The images are directed as image data to the event detection server or processor 186 that also receives inputs from a plan or program 187 that characterizes events and event detection and a clock 188 that establishes a timeline and timestamp for received images. The event detection server or processor 186 can also receive inputs from a GPS receiver 189 to stamp the position of the ship at the time of the event and can also receive input from an architectural plan 190 of the exemplary sea-going cargo vessel (that maps onboard locations on various decks) to stamp the position of the sensor within the vessel that sent the input. The event server/processor 186 can comprise one or more types and/or architectures of processor(s), including, but not limited to, a central processing unit (CPU—for example one or more processing cores and associated computation units), a graphical processing unit (GPU—operating on a SIMD or similar arrangement), tensor processing unit (TPU) and/or field programmable gate array (FPGA—having a generalized or customized architecture).

Referring again to FIG. 1A, the base location dashboard 172 is established on a per-ship and/or per fleet basis and communicates with the shipboard server 130 over the communications link 160 in a manner that is optionally reduced in bandwidth, and possibly intermittent in performing data transfer operations. The link 160 transmits events and status updates 162 from the shipboard server 130 to the dashboard 172 and event priorities, camera settings and vision system parameters 164 from the dashboard 172 to the shipboard server. More particularly, the dashboard displays and allows manipulation of events reports and logs 173, alarm reports and logs 174, priorities for events, etc. 175, camera setup 176 and vision system task selection and setup relevant to event detection, etc. 177. The shipboard server 130 includes various functional modules, including visual event bandwidth reduction 132 that facilitates transmission over the link 160; alarm and status polling and queuing 133 that determines when alarms or various status items have occurred and transmits them in the appropriate priority order; priority setting 134 that selects the priorities for reporting and transmission; and a data storage that maintains image and other associated data from a predetermined time period 135.

### II. Visual Detectors

As shown in FIG. 1B, various imaged events are determined from acquired image data using appropriate processes/algorithms 188 performed by the processor(s) 186. These can include classical algorithms, which are part of a conventional vision system, such as those available from (e.g.) Keyence, Cognex Corporation, MVTec, or HIK Vision. Alternatively, the classical vision system could be based on open source such as OpenCV. Such classical vision systems can include a variety of vision system tools, including, but not limited to, edge finders, blob analyzers, pattern recognition tools, etc. The processor(s) 186 can also employ machine learning algorithms or deep learning algorithms, which can be custom built or commercially available from a variety of sources, and employ appropriate deep-learning frameworks such as Caffe, Tensorflow, Torch, Keras and/or OpenCV. The network could be a masked R-CNN or Yolov3, Yolov5, Yolov8, or Yolov10 detector. See also URL address https:/engineer.dena.com/posts/2019.05/survey-of-cutting-edge-computer-vision-papers-human-recognition/ on the WorldWideWeb.

As shown in FIG. 1A, the visual detectors relate to maritime events 191, ship personnel safety behavior and events 192, hull and machinery maintenance operation and events 193, ship cargo condition and events related thereto 194, and/or non-visual alarms, such as smoke, fire, and/or toxic gas detection via appropriate sensors. By way of non-limiting example, some particular detected events and associated detectors relate to the following:
(a) A person is present at their station at the expected time and reports the station, start time, end time, and elapsed time;
(b) A person has entered a location at the expected time and reports the location, start time, end time, and elapsed time;
(c) A person moved through a location at the expected time and reports the location, start time, end time, and elapsed time;
(d) A person is performing an expected activity at the expected location at the expected time and reports the location, start time, end time, and elapsed time—the activity can include (e.g.) watching, monitoring, installing, hose-connecting or disconnecting, crane operating, tying with ropes;
(e) a person is running, slipping, tripping, falling, lying down, using or not using handrails at a location at the expected time and reports the location, start time, end time, and elapsed time;
(f) A person is wearing or not wearing protective equipment when performing an expected activity at the expected location at the expected time and reports the location, start time, end time, and elapsed time—protective equipment can include (e.g.) a hard-hat, left or right glove, left or right shoe/boot, ear protection, safety goggles, life-jacket, gas mask, welding mask, or other protection;
(g) A door is open or closed at a location at the expected time and reports the location, start time, end time, and elapsed time;
(h) An object is present at a location at the expected time and reports the location, start time, end time and elapsed time—the object can include (e.g.) a gangway, hose, tool, rope, crane, boiler, pump, connector, solid, liquid, small boat and/or other unknown item;
(i) That normal operating activities are being performed using at least one of engines, cylinders, hose, tool, rope, crane, boiler, and/or pump; and
(j) That required maintenance activities are being performed on engines, cylinders, boilers, cranes, steering mechanisms, HVAC, electrical, pipes/plumbing, and/or other systems.

Note that the above-recited listing of examples (a-j) are only some of a wide range of possible interactions that can for the basis of detectors according to illustrative embodiments herein. Those of skill should understand that other detectable events involving person-to-person, person-to-equipment or equipment-to-equipment interaction are expressly contemplated.

In operation, an expected event visual detector takes as input the detection result of one or more vision systems aboard the vessel. The result could be a detection, no detection, or an anomaly at the time of the expected event according to the plan.

Multiple events or multiple detections can be combined into a higher-level single events. For example, maintenance procedures, cargo activities, or inspection rounds may result from combining multiple events or multiple detections. Note that each visual event is associated with a particular (or several) vision system camera(s) 118, 180, 182 at a particular time and the particular image or video sequence at a known location within the vessel. The associated video can be optionally sent or not sent with each event or alarm. When the video is sent with the event or alarm, it may be useful for later validation of the event or alarm. In addition to compacting the video by reducing it to a few images or short-time sequence, the system can reduce the images in size either by cropping the images down to significant or meaningful image locations required by the detector or by reducing the resolution say from the equivalent of high-definition (HD) resolution to standard-definition (SD) resolution, or below standard resolution.

The shipboard server establishes a priority of transmission for the processed visual events that is based upon settings provided from a user, typically operating the on-shore (base) dashboard. The shipboard server buffers these events in a queue in storage that can be ordered based upon the priority. Priority can be set based on a variety of factors—for example personnel safety and/or ship safety can have first priority and maintenance can have last priority, generally mapping to the urgency of such matters. By way of example, all events in the queue with highest priority are sent first. They are followed by events with lower priority. If a new event arrives shipboard with higher priority, then that new higher priority event will be sent ahead of lower priority events. It is contemplated that the lowest priority events can be dropped if higher priority events take all available bandwidth. The shipboard server receives acknowledgements from the base server on shore and confirms that events have been received and acknowledged on shore before marking the shipboard events as having been sent. Multiple events may be transmitted prior to receipt (or lack of receipt) of acknowledgement. Lack of acknowledgement potentially stalls the queue or requires retransmission of an event prior to transmitting all next events in the priority queue on the server. The shore-based server interface can configure or select the visual event detectors over the communications link. In addition to visual events, the system can transmit non-visual events like a fire alarm signal or smoke alarm signal.

### III. Event Detection Flow

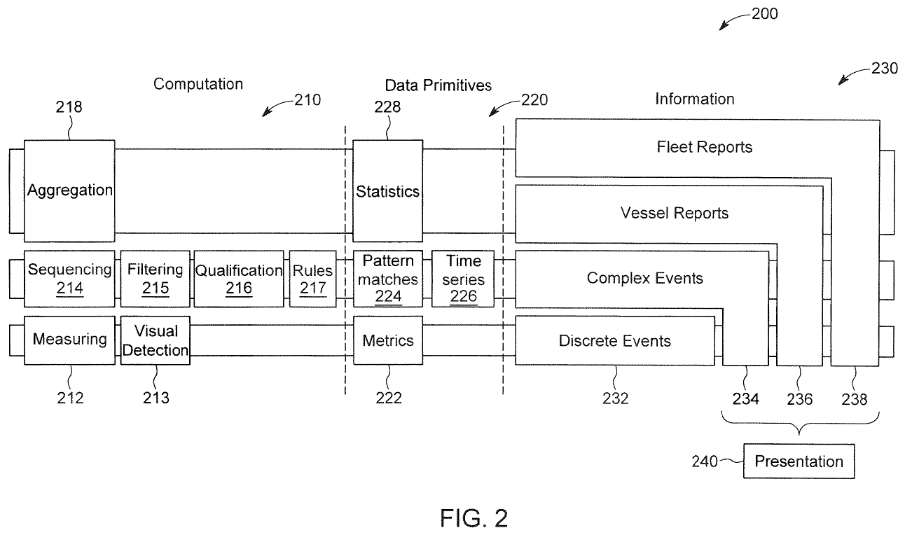

As shown in FIG. 2, an exemplary operating procedure 200 for generalized detection flow used in performing the system is shown. The operation can be characterized in three phases or segments, computation 210, generation of data primitives 220 and information creation 230 and presentation 240 to users via the shore-based dashboard. Alternatively, some or all of the functions herein can be implemented by users via a ship-based dashboard, which affects programming on at least one of the local server or the base server. The shipboard dashboard can also act as a passive terminal that transmits instructions back to the base interface over the communications link so that such instructions can be acted upon through the base. The computation phase 210 comprises measurement 212 using sensors and performing visual detection 213. These generate a set of metrics 222 that are displayed to the user as discrete events 232. The computation phase 210 uses event sequencing (priority) 214, filtering (via cropping, compression, etc.), and qualification of events 216 based upon rules 217 to provide pattern matches 224 according to a time series of events 226. This data is presented as complex events 234. These complex events 234 can comprise a scenario, such as a maintenance task successfully performed, or the occurrence of a safety breach. The computation phase 210 can aggregate visual and other events 218 and derive statistics 228—for example the number of safety breaches over a time interval, etc. These statistics 228 can be presented to the shore-based user as individual vessel reports 236 and fleet reports 238 that provide valuable information to the user regarding behavior and performance at various factors related to the events in aggregate.

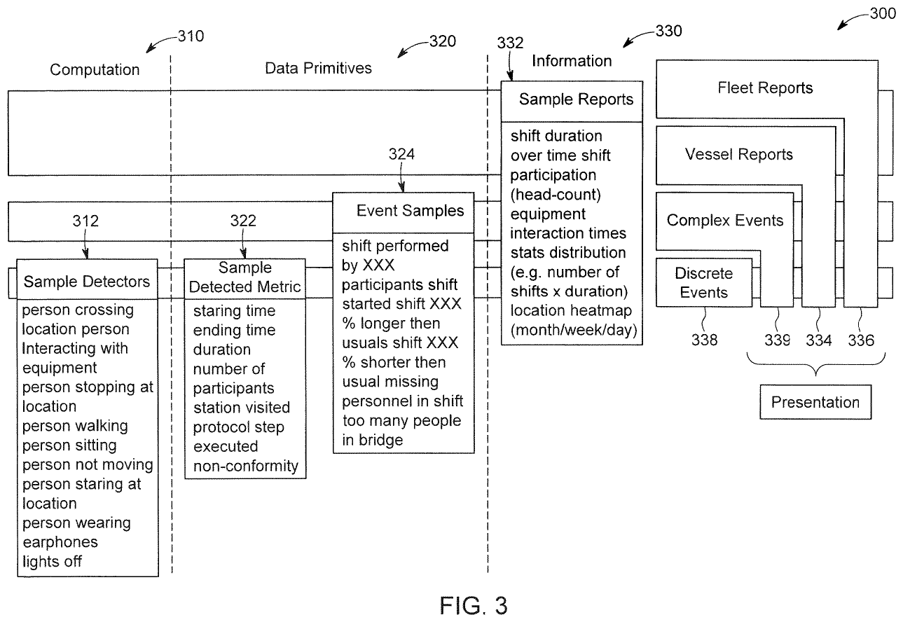

FIG. 3 shows a detection flow procedure 300 in the example of bridge routines for one or more vessels in a fleet. At the computation phase 310, the sample detectors 312 provided by visual and other detectors include (e.g.) a person crossing or stopping at a location, a person interacting with equipment, a person walking, sitting, not-moving (stationary), a person staring at a location, a person wearing earphones and/or lights off at the location. In the associated data primitives generation phase 320, sample detected metrics 322 are provided, including (e.g.) starting time and ending time, duration, number of participants, the bridge station visited, a protocol step executed and a non-conformity with protocols. Event samples 324 can include participant name(s) identified as performing the shift, when the shift started, whether a given participant's shift was longer or shorter than normal, missing personnel and/or excess/unauthorized personnel on the bridge. In the exemplary information phase sample reports 332 are created that can include (e.g.) shift duration over time, shift participation (head count), equipment interaction time statistics, distribution—for example number of shifts X duration and a location graph (e.g. a heat map) that can be based upon month, week, day, etc. In the information phase 330, the sample reports 332 can be presented as vessel reports 334 and fleet reports. Sample detected metrics 322 and event samples 324 can be presented to the user as discrete events 338 and complex events 339.

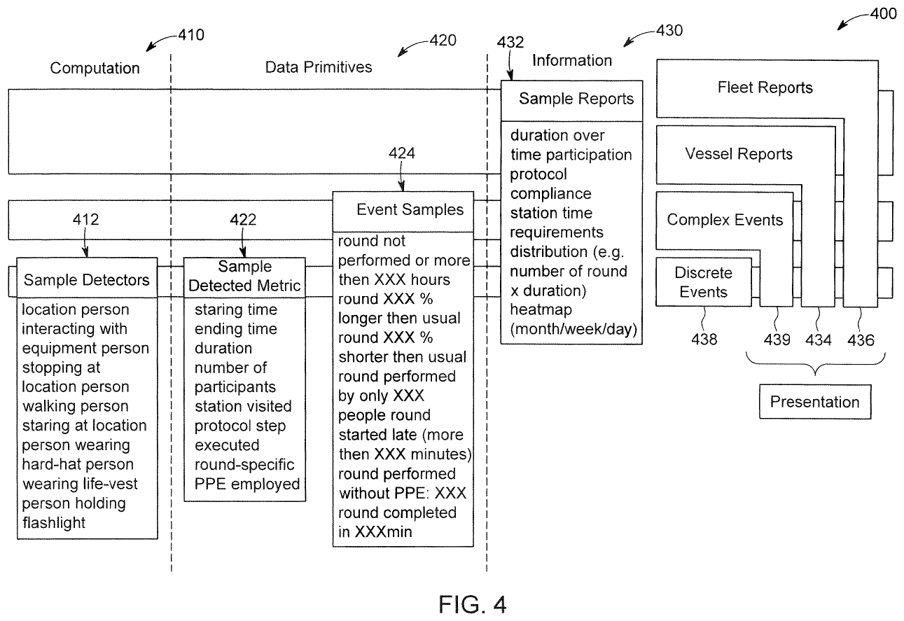

FIG. 4 shows a detection flow procedure 400 in the example of safety rounds for one or more vessels in a fleet. At the computation phase 410, the sample detectors 412 provided by visual and other detectors include (e.g.) the location of the event, person interacting with equipment, person stopping at a location, person walking or staring at a location, person wearing a hard-hat, life vest or other protective equipment and/or holding a safety tool, such as a fire extinguisher, flashlight, etc. In the data primitives phase 420 sample detected metrics can include (e.g.) starting or ending time of an event, duration, number of participants, station visited protocol step executed and/or round-specific protective equipment (PPE) employed. Event samples 424 can include whether a safety round was not performed for a predetermined number of hours and a round taking X % more or less time than normal, a round performed by X number of personnel, a round started late by X minutes, a round performed without needed PPE and/or a round completed in X minutes. The information phase 432 provides sample reports 432, based upon events, including duration over time, participation, safety protocol compliance, station time requirements, distribution (e.g. number of rounds X duration) and/or a graph/heat map based upon month, day, week, etc. Vessel reports 434 and fleet reports 436. The information phase 430 also reports discrete events 438 and complex events 439 based upon sample detected events 422 and event samples 424.

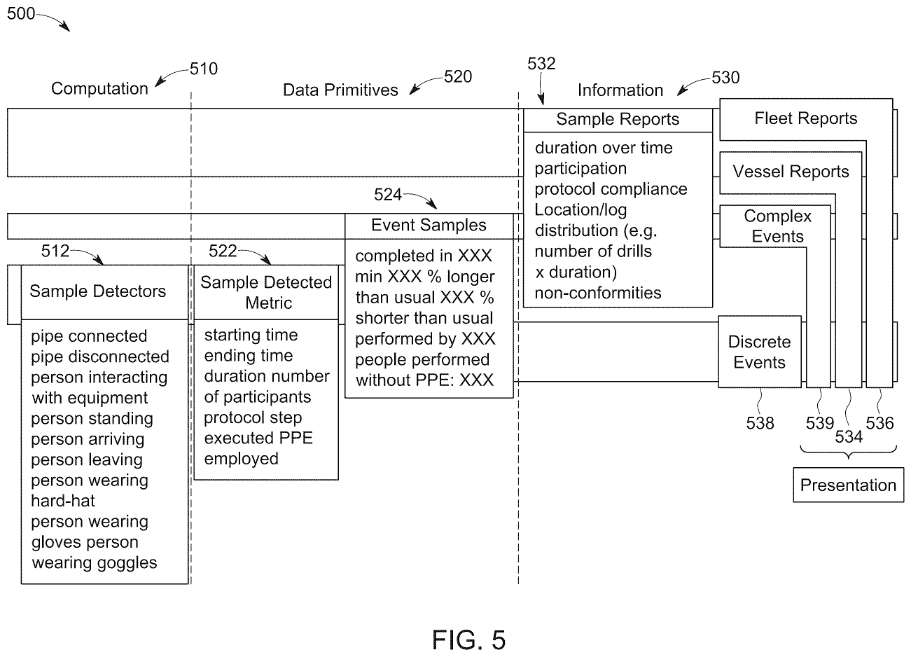

FIG. 5 shows a detection flow procedure 500 in the example of cargo operations for one or more vessels in a fleet. At the computation phase 510, sample detectors 512 can include a pipe connected, a pipe disconnected, a person interacting with equipment, a person standing, arriving or leaving, a person wearing a hard-hat, gloves, goggles and/or other PPE. The data primitives phase 520 provides sample detected metrics 522 include starting and ending time, duration number of personnel participating, a protocol step executed and/or PPE employed in the task(s). Event samples 524 can include a task complete in X minutes, task completion X % larger or shorter than usual, the task performed by X personnel and/or a task performed without (free of) PPE of X type. In the information phase 530 sample reports 532 can include duration over time, participation, protocol compliance, location/log, distribution (e.g. number of drills X duration) and/or non-conformities versus normal/standard operation. These can be presented as vessel reports 534 or fleet reports 536. Sample detected metrics 522 and event samples 524 are reported as discrete events 538 and complex events 539.

Other exemplary detection flows can be provided as appropriate to generate desired information on activities of interest by the ship's personnel and systems. Such detection flows employ relevant detector types, parameters, etc. Likewise, the mechanism to carry out detection can vary. In an alternate arrangement, expressly contemplated herein, event detectors can be partially or fully implemented using appropriate deep learning software algorithms/non-transitory computer-readable program instructions implemented on the shore-based and/or vessel-based processor(s). By way of non-limiting example an implementation of a “hybrid” detector arrangement using deep learning/artificial intelligence is shown and describe in commonly assigned U.S. patent application Ser. No. 17/873,053, entitled SYSTEM AND METHOD FOR AUTOMATIC DETECTION OF VISUAL EVENTS IN TRANSPORTATION ENVIRONMENTS, filed Jul. 25, 2022, the teachings of which are expressly incorporated by reference as useful background information.

### IV. Thermal Event Detection and Determination/Analysis

### A. Operational Overview

In an illustrative embodiment, the system and method herein allows for automatically diagnosing/detecting maritime visual thermal events for carried vehicles, cargo, marine engines, and machinery that is based on images taken with a thermal camera (for the detecting the rising temperature precursor) and a second method to detect a maritime visual fire precursor event based on images taken with a conventional camera and a computer vision algorithm that is executed on a processor.

With reference again to the system arrangement 100 of FIG. 1, the general arrangement, can include a plurality of thermal cameras TC that are located in interior (and optionally, exterior) locations of the vessel at which thermal events may occur-for example, electronics packages, engine room components, fuel storage, high-friction components, hazardous and/or flammable cargo locations, etc. Thermal cameras TC can be fixed or movable, with current locations logged in the system database with respect to a map (see 190 in FIG. 1B) of the vessel. By way of background discussion, thermal cameras typically produce two registered images simultaneously, a thermal image and a visible light image. These images can be displayed separately or superimposed by making one of the images partially transparent. The thermal image is typically lower resolution, for example 256×192 pixels, than the visible image, for example, currently 4096×2160 pixels or 2048×1080 pixels. The thermal image is typically pseudo-colored and the underlying greyscale values in the thermal image typically correspond to relative temperatures in the imaged scene, and not absolute temperature. Most cameras can optionally provide absolute temperatures if desired by the user-thus, if the temperature range in the image of the scene is 20 degrees C. to 35 degrees C., the displayed colors can range from 20 to 35, or can be remapped or rescaled for display With reference further to FIG. 1, processing arrangement 150 includes thermal event assessment module 157 and a thermal event reporting process(or) or module 158. In general, one or more of the thermal cameras TC are arranged to image an area (or multiple areas) of the vessel that are of concern for possible fire. Such areas can be typically within ship's interior, such as an engine room, bridge cargo hold, mechanical room, etc., but can also include various external areas, such as the car deck or container deck (which may contain hazardous or fire-prone cargo, such as lithium batteries. Not that these areas may also be imaged by standard visual cameras 118. Thus, if thick smoke appears, the visual cameras can also provide information to the processor 150, and that information can be correlated with the thermal event assessment and reporting modules 157 and 158, respectively.

The thermal profile of the imaged area defines a plurality of discrete characteristics that change over time. Thus, a series of acquired images can be stored and analyzed by operation the detection/determination process 157 with respect to the server and associated data storage 130. This thermal image data and the results of the determination pass over the network (LAN) 116, which consists of switches, routers and other components that allow passage of data packets via (e.g. TCP/IP) appropriate network protocols. As described below, the acquired thermal images of the area(s) are compared by the assessment process 157 to trained images of normal thermal conditions for that area, as well as various training images acquired by the same camera(s) during a normal (non-events) conditions associated with the time of day when the acquisition occurs) to detect a power-loss condition, as well as an emergency-lighting condition, and subsequent restoration of normal, generator-based power to the vessel.

The actual functions of these modules/processes (152-158) can be arranged in a variety of ways and instantiated on the shore-based server platform(s) 140 (via visual analytics 142), the vessel-based server 130, or both. Data 159 relative to the existence, timing and surrounding circumstances (e.g. navigation data, engine and generator telemetry, etc.) associated with one or more thermal event(s) over a given time period (and/or on an immediate alert basis) can be generated for display to a user on a local or remote interface dashboard (e.g. 134 or 172, respectively). The display can provide audible and visual (e.g. flashing red) alarms when a thermal event is detected. As described below, the dashboard can display information about a single vessel's camera's and/or about an entire fleet's cameras in accordance with the teachings of above-incorporated U.S. Pat. No. 11,908,189. Thermal event reports can also be part of a risk assessment function, such as described in commonly assigned U.S. patent application Ser. No. 17/973,675, entitled SYSTEM AND METHOD FOR MARITIME VESSEL RISK ASSESSMENT IN RESPONSE TO MARITIME VISUAL EVENTS, filed Oct. 26, 2022, the teachings of which are incorporated by reference as useful background information.

### B. System Operation

### 1. Overview

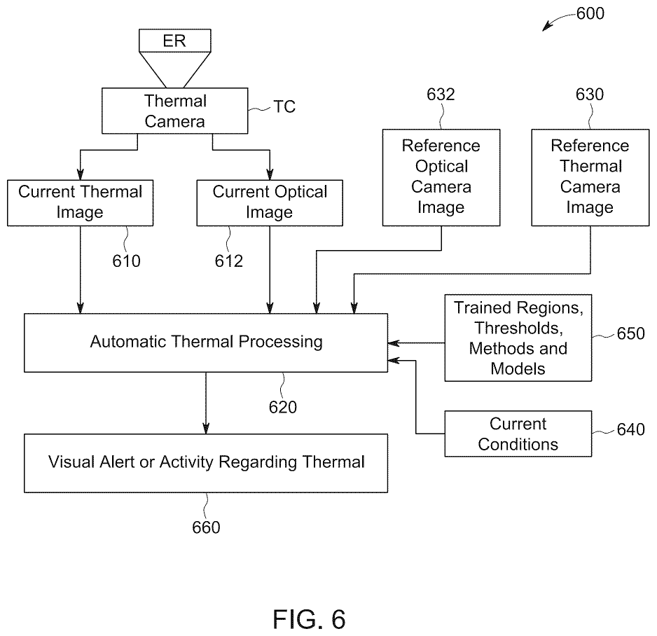

More generally, the system and method herein automatically visually detects maritime thermal events by using one or more thermal camera(s) TC connected to a processor 150 that measures the level of thermal activity in runtime versus trained image(s) of the scene. FIG. 6 shows a processing arrangement 600 for visual and thermal detection and analysis according to an illustrative embodiment. An exemplary thermal camera TC, which images a scene containing a potential fire risk FR, transmits both thermal image data (one or more image frames) 610 and a concurrent optical/visual image 612 to an automatic thermal process(or) module 620. The process(or) 620 also receives one or more reference thermal image(s) 630 and reference optical image(s) 632. The reference image(s) 630, 632 are provided from an appropriate database and are correlated to the location of the runtime imaged scene FR, and can optionally be correlated to a certain time of day and/or environmental condition(s) 640—for example hot daytime operation versus cool nighttime operation.

Based upon the conditions 640 and reference image(s) 630, 632, the thermal and optical runtime images 610, 612 are analyzed by the process(or) 620, based upon trained regions in the image, thresholds applied to the image data, as well as appropriate analysis methods and models 650. The analysis by the process(or) 620 thereby generates a result 660 comprising displayed and reported alerts and reports on thermal even activities.

### 2. Training Phase

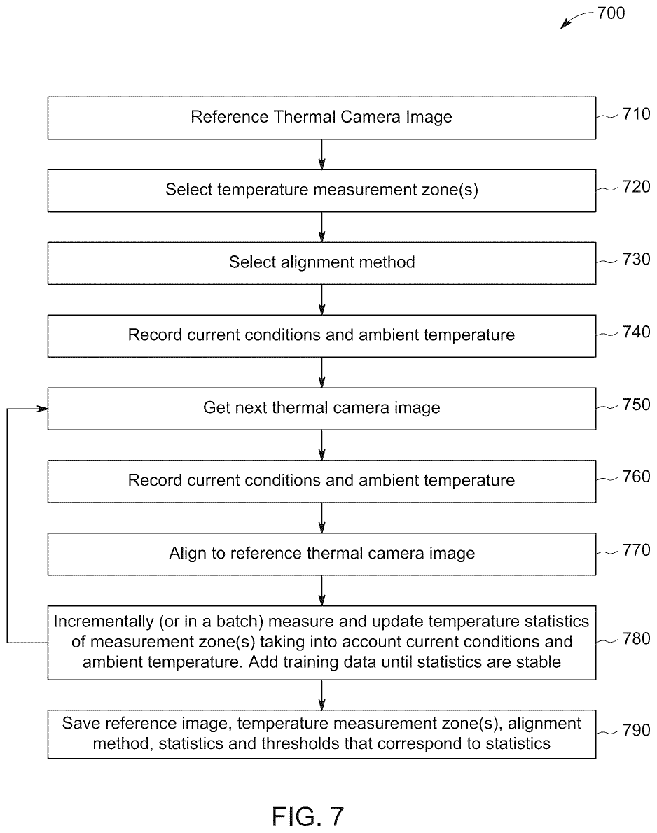

FIG. 7 shows a training process 700 that comprises an optional training phase for the process(or) 620. This training phase provides a template and associated parameters for thermal image(s) of carried vehicles, cargo, marine engines, or machinery on maritime vessels in order to establish a baseline (or multiple baselines which depend on ambient temperature and current operating conditions) average temperature, standard deviation of that temperature and potentially other statistics. The training procedure 700 involves acquiring an appropriate (initial) reference image 710 for training. In step 720, the procedure 700 selects one or more appropriate temperature measurement zone(s) in the locations of the first thermal reference image where the visual event detection will take place is selected. Next, the procedure selects an alignment method (such as Speeded-up Robust Features (SURF) alignment, minimizing difference of normalized correlation, minimizing difference of SSD, or output of an alignment deep learning network), used to align the first thermal image to subsequent thermal images, assuming that the camera position drifts over time and will need to be corrected (step 730). This can involve locating distinct image features (edges, outlines, shapes, patterns) that generally remain fixed between images. The procedure 700 then records the current operating conditions (whether the vessel is underway and/or at what speed or moored/anchored, day, night, position of the sun versus the scene) and ambient temperature in step 740, since these factors can influence temperature readings.

Note that a thermal image can be thought of as a 2 dimensional array of temperatures where the temperature at any coordinate in the image is a temperature pixel and represents the average temperature of a small area in the scene. Note that this temperature pixel at a small area of the scene is a different temperature compared to a much smaller area instantaneous temperature reading obtained by using a thermometer “gun” pointing at a single location somewhere inside the same area in the scene unless the temperature happens to be uniform across the entire area at that spot in the scene. The averaging process is quite important. Consequently, if a measured “hot spot” in the scene say an engine hose or electrical connection is much smaller than the measurement area of a temperature pixel, the temperature pixel measurement will include as an average the entire measurement small area will typically have a lower temperature than the “hot spot” itself.

The procedure 700 then processes subsequent/next acquired thermal images (step 750) following the reference image acquired in steps 710-740, so as to compare characteristics of subsequent acquired images to the reference image, and thereby establish (optional) training data for the temperature zone(s). This includes (a) recording current conditions and ambient temperature for each image, in turn in step 760; (b) aligning the subsequent thermal image to the first one (or just tracking) in step 770; (c) measuring the statistics of the temperature measurement zone in the thermal image over time (say mean and standard deviation or dependency of the zone on ambient temperature or time of day) in step 780. The goal is to determine “ambient” temperature of carried vehicle, cargo, marine engines or machinery at the current conditions, say with the ship traveling at 15 knots. This result is saved as a trained reference image, along with one or more value(s) for temperature measurement zone(s) thereof, that take into account current conditions and ambient conditions. The procedure step 780 adds training data to storage until the statistics become substantially stable.

The saved reference image from the above steps (step 790) includes known statistics of the temperature measurement zone(s) over time, the relevant alignment method, statistics and thresholds that correspond to those statistics. After this phase, we the system has trained knowledge of baselines and normal acceptable variations of temperature in each temperature measurement zone.

### 3. Runtime Phase

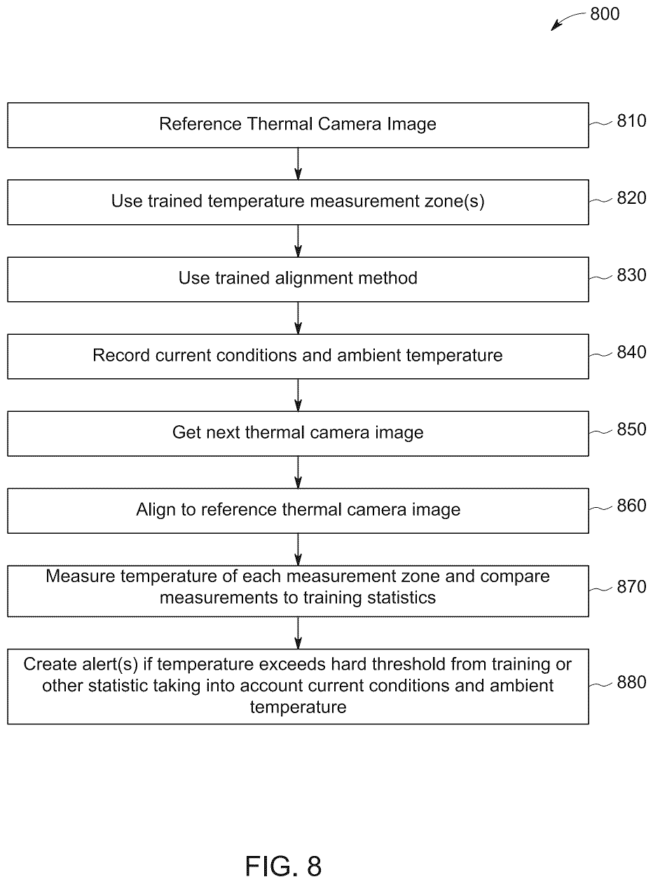

Reference is now made to FIG. 8, which shows a procedure 800 for operating a runtime thermal event detection in one or more established temperature zones. In the runtime phase, the thermal camera processor is processing thermal image(s) of carried vehicles, cargo, marine engines or machinery. Runtime involves selecting a temperature measurement zone (step 820) in the first acquired reference thermal image 810 where the visual event detection will take place. This zone should be the same or a subset of the training zone described above (unless no zone was trained). The procedure then sets up the alignment method that will align the first thermal image to subsequent thermal images. This method could be the same as that employed during training (step 830). The procedure then records current conditions and ambient temperature in step 840.

The runtime procedure 800 then processes subsequent, acquired thermal images (step 850). The procedure 800 thereby aligns the subsequent, thermal image to the first one (or just tracking) in step 860. In step 870, the procedure 800 then compares the temperature measurement zone in the thermal image to the first thermal image (for example, by subtracting the two temperature measurement zones from each other and looking at the mean increase in temperature) or by using a hard threshold on the absolute temperature measurement. When using a hard threshold on absolute temperature, the above-described training phase is optional. Determining the hard threshold can be performed during training and can take into account current conditions.

The procedure 800 reports the temperature measurement zone mean temperature as a visual alert (step 880), as well as checking if the increase in temperature over baseline is beyond the normal acceptable variation in temperature. The procedure 800 can also be structured as a machine learning (AI/deep learning) problem where the machine learning process learns all of the necessary statistics and thresholds by collecting and labelling observations.

As discussed, thermal events, and corresponding visual smoke events, can be transmitted over a reduced (or conventional) bandwidth wireless communication link to the shore based computing system/server. Such transmission can be prioritized (as high/highest (and/or overriding other communications) in the message hierarchy. Such thermal and smoke events can also cause communication to be initiated outside of a normally scheduled transmission time so as to immediately inform land-based staff of a potential emergency so that appropriate steps can be taken on shore and (by radioing) the ship based crew.

### 4. Smoke Detection

Part of thermal detection and fire risk assessment entails detection of compact, dense smoke, which can occur at or before the beginning of a fire. The method for detecting compact dense smoke is based on visual cameras (118) in this embodiment. Smoke detection, like thermal detection, consists of both a training and a runtime phase.

### (a) Smoke Training Phase

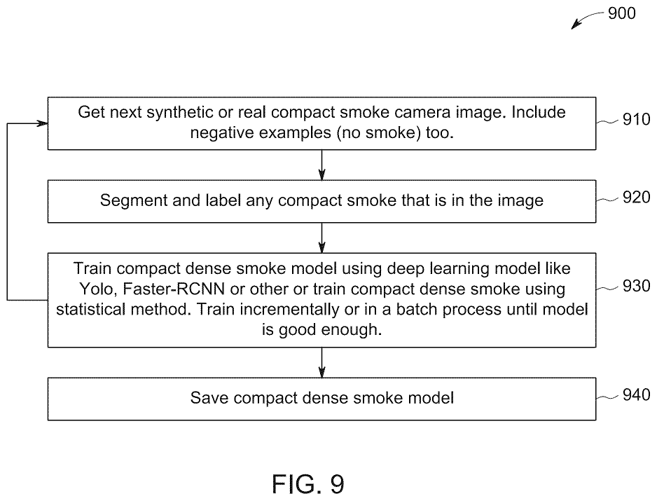

Reference is made to FIG. 9, which shows a procedure 900 for training of smoke detection with visual camera(s), which can be directed toward the same scene as the thermal camera(s), or at different/additional scenes so as to provide wider detection coverage. The procedure 900 is provided with a synthetic smoke image that is input from one or more database(s), and/or an actual (visible) compact smoke image from an appropriate database. The image(s) define specific maritime locations, such as ship engine room, ship generator room, ship cargo bay and/or shipping container storage location. The location can also be part of car-carrier deck. Part of the training can entail automated or manual labelling (currently or via previous actions) of compact smoke present in these ship-based locations in each of the image(s). The compact smoke label(s) are stored with the associated image(s) in the database (step 920).

The procedure 900, in step 930, then trains for compact dense smoke using supervised learning via a plurality of deep learning models using a deep learning object detector such as Yolo, Faster R-CNN and/or other publicly/commercially available deep learning algorithms. The trained compact dense smoke model derived above is saved in a database in association with the appropriate ship location.

### (b) Smoke Runtime Phase

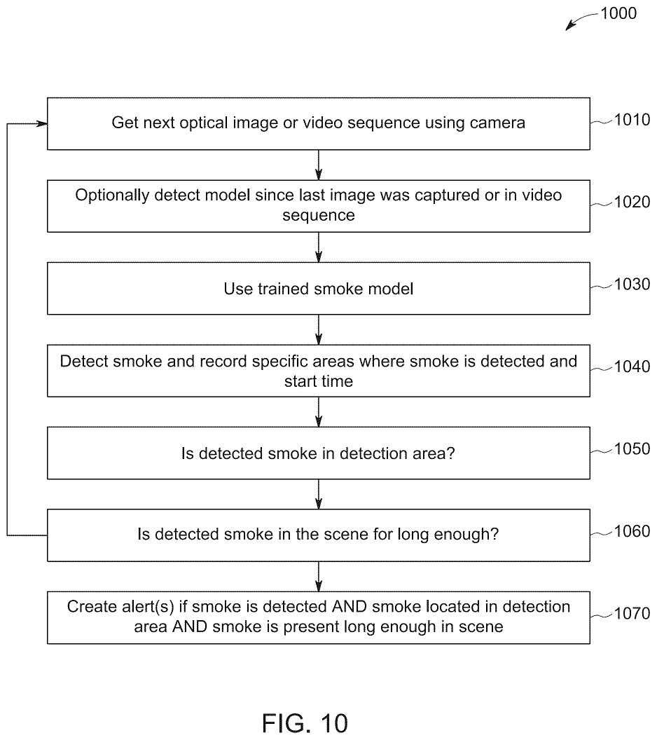

Reference is made to FIG. 10, which shows a runtime procedure 1000 for smoke detection based upon the model(s) trained according to the training procedure 900 (FIG. 9) above. In step 1010, the runtime smoke detection procedure 1010 acquired an image, or a sequence of images, onboard the vessel using a visual camera directed at the scene/area of interest. The procedure 1000 can optionally detect motion in the image(s) by comparing the scene to a stored model or previously stored image using a conventional computer vision technique, such as optical flow (step 1020). The procedure 1000 then detects compact dense smoke (step 1040) using the training model (step 1030) for the associated location, which was trained in the training phase in step 1030. The detected smoke in specific areas of the image is then recorded with an associated start time. The procedure 1000 also determines if the detected smoke is occurring in an associated detection area in step 1050. Given the current location of the detected smoke and the start time of the detection, the procedure loops (branch 1062) via step 1060 to determine if a sufficient (threshold—for example, 10s of seconds to ensure a true positive event) time interval has occurred with smoke continually present at the location. If the smoke remains detected at the location over the predetermined threshold time, then the procedure 1000 creates appropriate visual and/or audible alert(s)/alarms that can be issued to the user interface display, along with any thermal event information, and are also stored in the system event storage database, in the manner of other safety events herein.

Optionally the procedure can intersect a fixed smoke detection attention zone (that is manually or automatically defined in the image based upon surrounding image features—e.g. those that would assist n differentiating smoke, like a contrasting shade or color) with the detection result to limit the detection away from areas which may be highly likely to produce false positives such as around ambient illumination. More particularly, the attention zone process herein can interoperate with a conventional computer vision process or a deep-learning-based computer vision process to detect compact smoke particularly within the attention zones. A positive detection result, given that it also meets any predetermined time and duration thresholds/parameters, can then be converted into an appropriate alert to users and/or recorded in the system event database onboard the vessel and/or on shore via the wireless link.

Note that smoke events and thermal events can each be recorded and reported separately, or can be combined to provide fire precursor event data. More generally, either event can form the basis of an alarm prompting investigation by shipboard crew and, if necessary, firefighting personnel.

### C. Container Ship Implementation

### 1. Vessel and Cargo Details

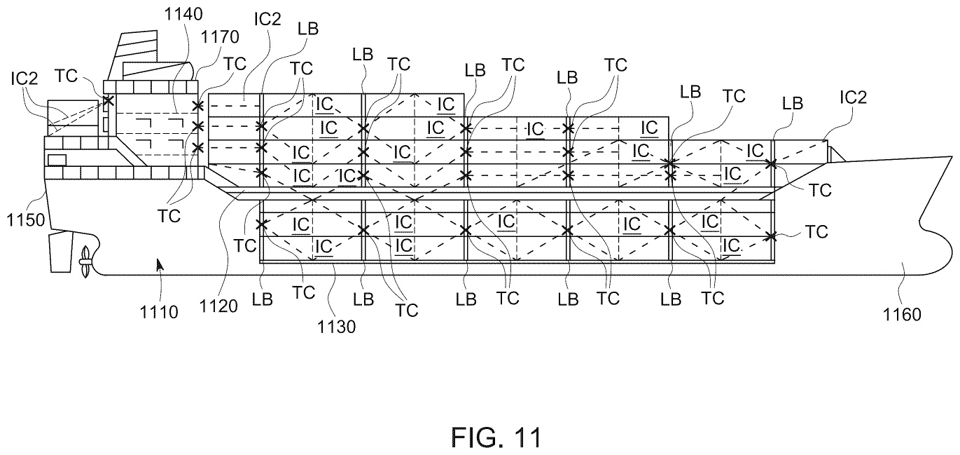

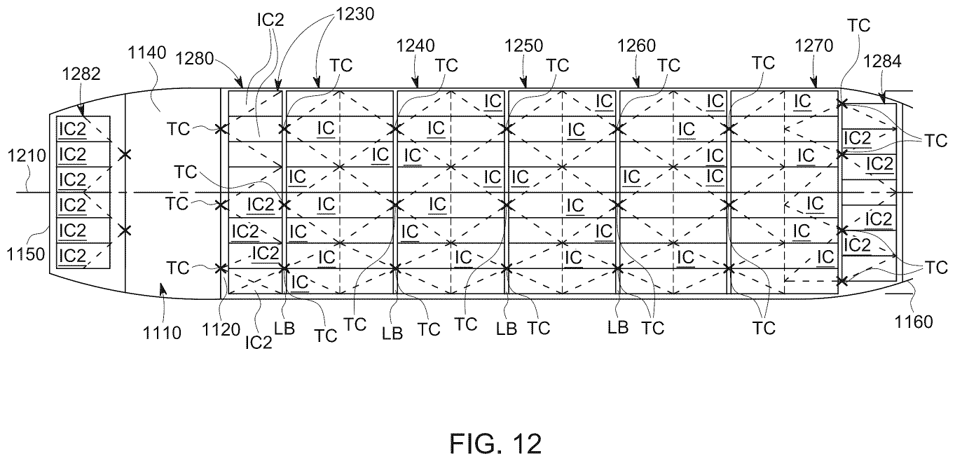

FIGS. 11-14 show an exemplary cargo vessel arranged as typical container ship 1110. The container ship 1110 carries stacks of containers IC in rows and columns on its deck 1120 and relative to a depressed hold 1130. Crew quarters, the bridge and various control/administrative functions are carried out in a raised superstructure 1140, that is typically located near the stern 1150 of the ship, opposite the bow 1160. The bridge 1170 is typically located at the top of the superstructure and can afford the crew a panoramic view of the surrounding environment as well as the deck 1120 and containers IC. Containers IC are stacked in vertical columns, in a plurality of rows (a maximum of 8 in the exemplary vessel 1110) extending across the ship centerline 1210 (FIG. 12), from port side to starboard side. A full length container IC has a length of approximately 40 ft, while a half-length container IC2, has a length of approximately 20 ft. The bays 1230, 1240, 1250, 1260 and 1270 of the exemplary vessel 1110 are arranged to each accommodate an (e.g. 8-container) row of stacked full-length containers of predetermined height. Note that half-length (e.g. 20-foot) containers can be substituted in one or more locations of the bays 1230-1270 where appropriate, as indicated by dashed lines down the middle of the full-size containers IC. Half-length container bays 1280 and 1282 are provided, for example, on either side of the superstructure 1140 and adjacent to the bow (bay 1284). Again, the depicted container arrangement herein is exemplary of a wide range of possible configurations that can be unique to the size and shape of vessel.

Notably, each bay 1230-1270 of the vessel 1110 is bounded from port to starboard (transverse to the centerline 1210) by lashing bridges LB that are strong, mechanical, steel structures installed on the deck 1120 between the bays, and are built to allow for secure stowage of stacks of containers IC, IC2. Each lashing bridge LB provides attachment points for lashing equipment, such as turnbuckles and rods, which are used to secure container stacks against vessel's motion at sea.

### 2. Camera Arrangement

An illustrative arrangement of thermal imaging cameras TC (and optionally conventional cameras) for use in detecting heat and (optionally) dense smoke in a stack of intermodal containers IC arranged on a deck 1120 and hold 1130 of a container ship 1110. Typically, the above-described system and method can be applied to at-risk containers in a container ship having the above-described rows and columns of stacked containers arranged on a deck 1120, and in the hold 1130 of the ship.

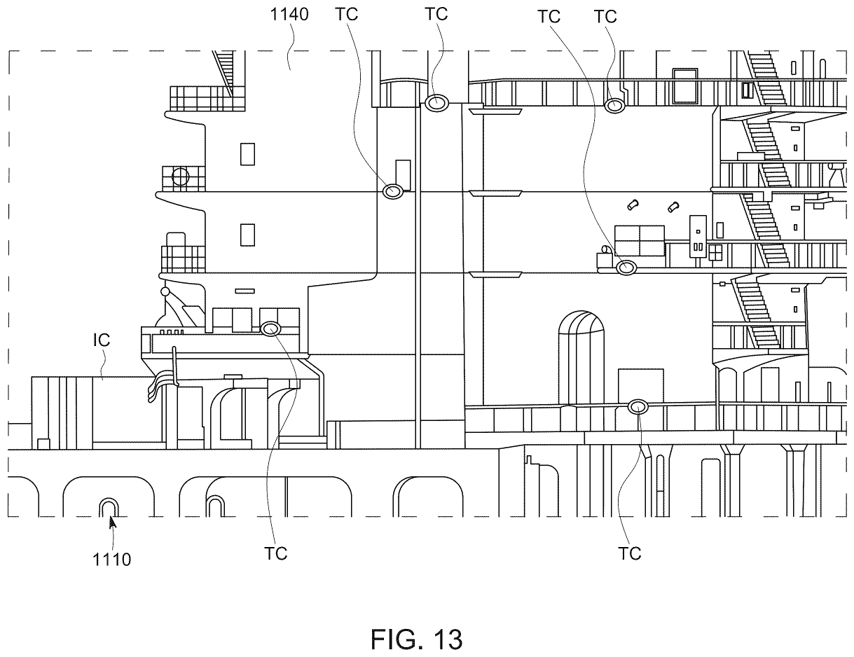

Illustratively, some or all of the thermal imaging cameras employed herein can be used to image known locations for such at-risk containers, or can be used to image at least a portion of substantially all containers carried on the vessel, particularly due to contents any of the containers being potentially mis-declared (and, thus flammable). As shown, thermal cameras TC, shown by respective Xs, and/or conventional camera(s) are installed and fixed on the lashing bridges LB as well as the superstructure 1140 (see also FIG. 13) at strategic locations that allow for all containers of interest to be imaged sufficiently to determine if elevated heat (or dense smoke) is present. In this example, each camera TC on a lashing bridge LB consists of a pair of cameras facing in opposing directions so as to image each of adjacent bays. A plurality of cameras TC are positioned with respect to the containers.

The exact positioning of cameras TC depends upon the configuration of container stacks and bays. The depicted placement shows exemplary fields of view (FOVs) for each camera (X). It is assumed that, unless partially occluded, each FOV defines an outwardly tapered rectangle or cone. Thus, at longer range, the camera can image a wider range, encompassing multiple containers. The FOVs are shown by dashed lines with respect to each camera, and are provided merely by way of example. The goal of camera placement should be to image at least one of the six sides of the container, noting that if the containers are stacked closely one on top of another, there may only be visibility of one side of the container along the aisle. As such, sufficient cameras should be installed to afford line-of-sight to each container that requires monitoring by the system and method herein. As heat with spread relatively rapidly through metal container walls, acquiring an image of even a portion of a wall can be sufficient to indicate a fire in that container.

### 3. Camera Connectivity

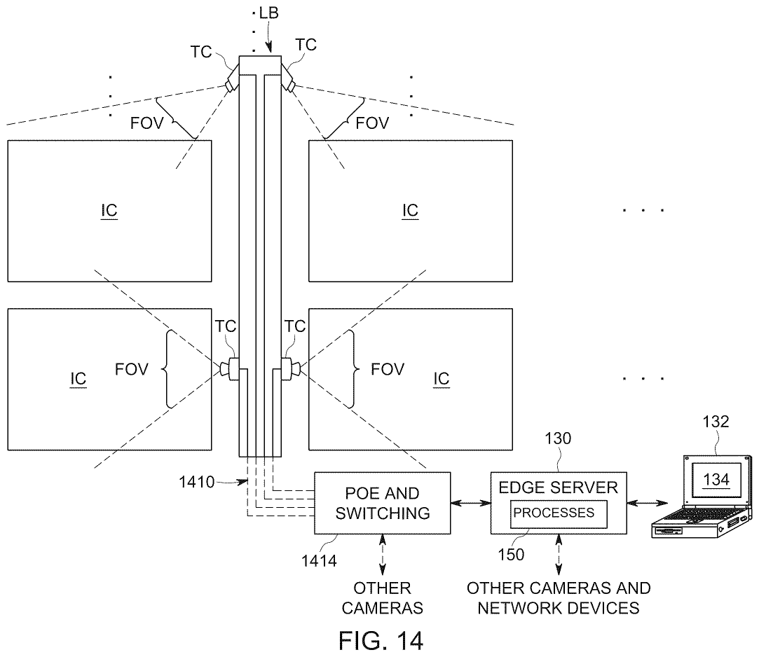

With further reference particularly to FIG. 14, cameras should be weatherproof and mounted so as to avoid interference with normal vessel functionality. As cameras are generally small in scale relative to vessel construction and components, it should be clear to those of skill how to mount and orient cameras so as to achieve effective and efficient imaging of containers of interest without interfering with vessel mechanical systems. In some implementations, multiple cameras can be installed on a single mounting position, directed to image different FOVs. Note also that cameras TC can be installed on removable portions of the lashing bridge structures—for example clamped onto turnbuckle rods at appropriate viewpoints after the containers are secured. Likewise, specialized poles or extensions can be temporarily or permanently installed onto beams of the lashing bridge(s) to extend cameras TC and their associated FOVs into locations remote from beams or other solid bridge structures. Where applicable (see below) appropriate weatherproof power and/or data cables can be run in a non-interfering manner to connection hubs or other structures/devices that interconnect with a switch and/or the vessel's server arrangement. Where cameras TC are installed in temporary locations, calibration and training may be required in accordance with the teachings herein and ordinary skill.

As cameras consume electrical power, convention weather-proof cables and/or conduits 1410 can be employed to supply power, and optionally to carry back a video (analog or digital) signal from each camera TC to a network switch 1414, or other appropriate signal distributing device. The video signal can be optionally transmitted wirelessly in alternate implementations. Likewise, local or area-based solar panels/batteries of sufficient capacity can be used in conjunction with cameras TC to achieve a full wireless implementation in a manner clear to those of skill.

In this embodiment, the switch 1414 operates similarly or identically to the above-described switch 114 (FIG. 1). The switch 1414 can optionally include conventional power-over-ethernet (POE), so that both data and power are provided to each camera TC on a single ethernet cable. The switch, and others, as appropriate, interface with the edge server or other appropriate vessel-based computing device 130. As described above, the server 130 carries out various processes 150 that generate thermal event data 159 and alerts provided to a remote interface computer/device 132 on a user interface screen 134, as described above. The server 130 can also trigger general alarms, including horns, sirens, lights, etc. to alert the crew as to a thermal event/possible cargo fire.

Note that results of thermal event processes (as described in FIGS. 6-10 above), as applied to containers and their cargo, can be retained within the storage associate the onboard vessel server 130—being free of concurrent transmission to the shore-based system in various embodiments. This saves bandwidth and avoids system-wide reporting of false alarms and minor thermal events that do not affect vessel safety or operation. If thermal events exceed a certain threshold—e.g. temperature, effected area, number of containers involved, etc.—then an appropriate flag can be placed on the thermal event, and it can be transmitted to the shore based system 140, 170.

### 4. Training and Runtime Operation

The system is trained to recognize thermal events in containers within each camera's FOV in a manner described generally above for other objects. Training can be based on a previous set of stacked containers having certain visual and thermal profiles. More than one container/container side (or portions of sides) can appear in the particular camera's FOV, and the system recognizes and registers edges using appropriate conventional or AI-driven vision tools to delineate containers in the imaged scene. Alternatively, training of a particular scene containing containers can occur as part of the pre-voyage processes conducted by the crew. Thus, the actual container layout is imaged by the cameras after loading is completed. If at-risk containers are known and verified, then only those containers (and the cameras imaging them) can be flagged by the system operator. Other containers are not imaged, or imaged in a different manner that may, or may not, include thermal imaging. Training can include acquiring reference thermal images of containers at different times of day to ensure environmental (solar) heating and cooling is accounted for. Reference thermal images can be provided for different weather conditions if appropriate.

In operation, containers are imaged as objects using the processes described hereinabove, including FIGS. 6-10. That is, the generalized thermal event determination process periodically compares one or more reference image(s) of the identified container (sides) to a set of the conditions in one or more acquired current thermal image(s) of the container (sides) within the FOV of at least one thermal camera. This comparison is used to determine whether a thermal event condition is present based upon the acquired current thermal images. If a positive thermal event in a particular container is detected, then the crew is alerted, and appropriate action can be taken. This can include dispatching fire-fighting equipment, ejecting one or more containers—if accessible—from the vessel, signaling for assistance if reasonably close, or in the most extreme case abandoning ship.

Because the cameras TC operate in an outside environment, they can be susceptible to occluding conditions, such as rain, ice, snow, fog, smoke, etc. To avoid false alarms, cameras can undergo periodic health checks that account for such conditions, and may discount the camera's data if appropriate. Commonly assigned U.S. patent application Ser. No. 18/657,543, entitled SYSTEM AND METHOD FOR AUTOMATIC DIAGNOSIS, CONTROL AND RESTORATION OF MARITIME VISUAL SENSORS, filed May 7, 2024, the teachings of which are incorporated herein by reference, describes a technique for determining camera “health” including cameras that are compromised by external environmental conditions. These techniques can be employed to temporarily or permanently discount camera data where health falls below a predetermined threshold.

### IV. Conclusion

It should be clear that the above-described system and method provides an effective mechanism for early detection and recording of thermal events that are precursors for potentially catastrophic fires on maritime commercial and similar vessels, including those carrying intermodal shipping containers. In particular, the use of trained thermal cameras, taken alone, or in combination with preexisting visual cameras, which are trained to detect dense compact smoke, allows for reliable and early detection of such precursors.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. For example, as used herein, the terms “process” and/or “processor” should be taken broadly to include a variety of electronic hardware and/or software-based functions and components (and can alternatively be termed functional “modules” or “elements”). Moreover, a depicted process or processor can be combined with other processes and/or processors or divided into various sub-processes or processors. Such sub-processes and/or sub-processors can be variously combined according to embodiments herein.

Likewise, it is expressly contemplated that any function, process and/or processor herein can be implemented using electronic hardware, software consisting of a non-transitory computer-readable medium of program instructions, or a combination of hardware and software. Additionally, as used herein various directional and dispositional terms such as “vertical”, “horizontal”, “up”, “down”, “bottom”, “top”, “side”, “front”, “rear”, “left”, “right”, and the like, are used only as relative conventions and not as absolute directions/dispositions with respect to a fixed coordinate space, such as the acting direction of gravity. Additionally, where the term “substantially” or “approximately” is employed with respect to a given measurement, value or characteristic, it refers to a quantity that is within a normal operating range to achieve desired results, but that includes some variability due to inherent inaccuracy and error within the allowed tolerances of the system (e.g. 1-5 percent). Accordingly, this description is meant to be taken only by way of example, and not to otherwise limit the scope of this invention.

What is claimed is:

1. A system for automatically detecting a thermal event in a commercial maritime vessel carrying shipping containers as part of an automated visual event detection system comprising:
at least one thermal camera mounted to image at least one side of one of the shipping containers for thermal events;
at least one processor residing on the vessel, adapted to receive thermal image data over a local network from the at least one thermal camera and generate thermal event information relative to the data;
a data store associated with the processor that receives thermal image data from the thermal camera of the at least one side, the data store providing live thermal images of the at least one side and storing reference images of the at least one side associated with a plurality of conditions; and
a thermal event determination process that periodically compares one or more reference images of an area containing the at least one of the shipping containers, including the at least one side, to a set of the conditions in one or more acquired current thermal images of the at least one side by the at least one thermal camera, and determines therefrom whether a thermal event condition is present based upon the acquired current thermal images.

2. The system as set forth in claim 1, further comprising a communication link that transmits, based upon predetermined threshold conditions, the thermal event information from the processor to a land-based remote computer system that stores, analyzes and displays the thermal event information.

3. The system as set forth in claim 2, wherein the communication link defines a reduced bandwidth, wherein the information is transmitted in an order as part of a hierarchy of event information based upon significance thereof.

4. The system as set forth in claim 1, further comprising a storage arrangement residing on the vessel in association with the processor, that stores the thermal event information, including a time and a duration of the thermal event in a land-based database on shore or in a cloud data storage.

5. The system as set forth in claim 1, wherein the at least one thermal camera is located on a superstructure or lashing bridge of the vessel.

6. The system as set forth in claim 5, further comprising weatherproof cables that carry power and data to and from the at least one thermal camera and are operatively connected with the processor.

7. The system as set forth in claim 1, wherein the at least one thermal camera images a plurality of sides associated, respectively, with a plurality of adjacent shipping containers.

8. The system as set forth in claim 7, wherein each thermal image is divided into temperature measurement zones that are analyzed separately for change in temperature in a plurality of thermal images by the processor.

9. The system as set forth in claim 8, further comprising a tracking process that aligns the temperature measurement zone in a first of the plurality of thermal images to a second thermal images.

10. The system as set forth in claim 9, wherein the tracking process includes an alignment process that chooses from at least one of a plurality of alignment methods.

11. The system as set forth in claim 9, further comprising a comparison process that compares the two aligned temperature measurement zones using a minimum criteria for temperature or change in temperature consisting of both a minimum contiguous area and a minimum temperature or change in temperature.

12. The system as set forth in claim 11, further comprising a determination process that converts a result of the comparison process into a visual alert that is reported to a user.

13. The system as set for the in claim 1, wherein the processor receives visual event information of compact smoke from images acquired by at least one visual camera of the at least one of the shipping containers, and determines presence of compact smoke based upon predetermined characteristics in one or more of the images.

14. The system as set forth in claim 13, wherein the predetermined characteristics include a time of the determined presence and a duration of the determined presence of compact smoke in at least two of the images.

15. The system as set forth in claim 14, further comprising a communication link that transmits, based upon predetermined conditions, the visual event information of compact smoke from the processor to a land-based remote computer system that stores, analyzes and displays the visual event information of compact smoke.

16. The system as set forth in claim 14, further comprising an attention process that defines an attention zone in the image to search for the compact smoke.

17. The system as set forth in claim 16, wherein the processor includes at least one of a conventional computer vision process and a deep learning computer vision process that detects the compact smoke in each of the images, and a comparison process that uses results of the at least one of the conventional computer vision process and the deep learning computer vision process computer vision method, in combination with attention process, to validate the detection of the compact smoke.

18. The system as set forth in claim 17, further comprising a determination process that uses respective detection of the compact smoke from a two or more images to provide a visual alert of the compact smoke to a user.

19. The system as set forth in claim 1, wherein the processor is operatively connected to instruct a vessel-based alarm system to issue at least one of an audible and visible alert based upon determination of the thermal event condition.

20. A method for automatically detecting a thermal event in a shipping container carried on a commercial maritime vessel as part of an automated visual event detection system comprising the steps of:
providing at least one thermal camera that images at least one side of at least one shipping container for thermal events on a maritime vessel;
receiving, with at least one processor on the vessel, thermal image data over a network from the at least one camera and generate thermal event information relative to the data;
receiving, at a data store associated with the processor, thermal image data from the at least one thermal camera the at least one side, the data store providing live thermal images of the at least one side, and storing reference images of the at least one side associated with a plurality of conditions; and
determining the thermal event by periodically comparing one or more reference images an area containing the at least one of the shipping containers, including the at least one side, to a set of the conditions in one or more acquired current thermal image(s) of the at least one side, and determining therefrom whether a thermal event condition is present based upon the acquired current thermal images.

21. The method as set forth in claim 20, further comprising, imaging by the thermal camera, the at least one side, and providing, by the thermal camera, at least two thermal images of the carried vehicle, cargo, marine engine or machinery, respectively, where the images are acquired at two different times using the thermal camera from the same vantage point.

22. The method as set forth in claim 21, further comprising, dividing each thermal image into temperature measurement zones, and separately analyzing the temperature measurement zones for change in temperature in a plurality of thermal images.

23. The method as set for the in claim 20, further comprising, receiving by the processor, visual event information of compact smoke from images acquired by at least one visual camera of the at least one shipping container, and determining presence of compact smoke based upon predetermined characteristics in one or more of the images.

24. The method as set forth in claim 20, wherein the step of providing includes locating the at least one thermal camera on a superstructure or a lashing bridge of the vessel

25. The method as set forth in claim 20, further comprising, instructing a vessel-based alarm system to issue at least one of an audible and visible alert based upon determination of the thermal event condition.
